(19) United States
(12) Patent Application Publication
(10) Pub. No.: US 2023/0153616 A1
(43) Pub. Date: May 18, 2023

(54) MULTIPLY-ACCUMULATE SHARING CONVOLUTION CHAINING FOR EFFICIENT DEEP LEARNING INFERENCE

(71) Applicant: Intel Corporation, Santa Clara, CA (US)

(72) Inventors: Liron Ain-Kedem, Kiray Tivon (IL); Guy Berger, Shmuel, IL (US); Maya Rotbart, Santa Clara, CA (US); Guy Zvi Ben Artzi, Yaacov, IL (US)

(21) Appl. No.: 18/148,057

(22) Filed: Dec. 19, 2022

(51) Int. Cl. G06N 3/08; G06F 7/523

(52) U.S. Cl. CPC G06N 3/08; G06F 7/523

(57) ABSTRACT

Systems, apparatuses and methods may provide for technology that chains a plurality of convolution operations together, wherein the plurality of convolution operations include one or more one-dimensional (1D) convolution operations and one or more two-dimensional (2D) convolution operations, streams the plurality of convolution operations to shared multiply-accumulate (MAC) hardware, wherein to stream the plurality of convolution operations to the shared MAC hardware, the technology swaps weight inputs to the shared MAC hardware with activation inputs to the shared MAC hardware based on convolution type, and stores output data associated with the plurality of convolution operations to a local memory. Each of the 2D convolution operations may include a multi-cycle multiplication operation.

### TECHNICAL FIELD

Embodiments generally relate to machine learning (ML) neural network technology. More particularly, embodiments relate to multiply-accumulate (MAC) sharing convolution chaining for efficient deep learning inference in neural networks.

### BACKGROUND OF THE DISCLOSURE

In machine learning, a convolutional neural network (CNN, e.g., ConvNet) is a type of feed-forward artificial neural network in which the connectivity pattern between neurons is inspired by the organization of the animal visual cortex (e.g., individual neurons are arranged in such a way that they respond to overlapping regions tiling the visual field). In most modern CNNs, point wise convolution (PWC) operations and depth wise convolution (DWC) operations are used to reduce the multiply-accumulate (MAC) computation overhead associated with full convolution operations (e.g., C2D). PWC operations are typically structured according to weights and activations bandwidth tradeoffs. DWC operations, on the other hand, have a substantially different way of calculation compared to PWC operations. Accordingly, DWC solutions typically result in inefficient use of MAC hardware or involve the use of a different MAC structure (e.g., a dedicated set of MACs for the DWC operations).

### BRIEF DESCRIPTION OF THE DRAWINGS

The various advantages of the embodiments will become apparent to one skilled in the art by reading the following specification and appended claims, and by referencing the following drawings, in which:

FIG. 1 is an illustration of an example of a convolutional neural network (CNN);

FIG. 2 is an illustration of an example of a multiply-accumulate (MAC) sharing solution according to an embodiment;

FIG. 3 is a block diagram of an example of a machine learning architecture according to an embodiment;

FIG. 4 is a block diagram of an example of a chained convolution solution according to an embodiment;

FIG. 5 is a block diagram of an example of a MAC sharing chained convolution solution according to an embodiment;

FIGS. 6A-6C are illustrations of examples of the use of adder tree multipliers for various filter sizes according to an embodiment;

FIGS. 7A and 7B are flowcharts of examples of methods of operating a performance-enhanced computing system according to embodiments;

FIG. 8 is a flowchart of an example of a method of streaming a plurality of convolution operations to shared MAC hardware according to an embodiment;

FIG. 9 is a block diagram of an example of a performance-enhanced computing system according to an embodiment; and

FIG. 10 is an illustration of an example of a semiconductor package apparatus according to an embodiment.

### DETAILED DESCRIPTION

In general, a neural network model (e.g., CNN) may receive training and/or inference data (e.g., images, audio recordings, etc.), where the neural network model may generally be used to facilitate decision-making in autonomous vehicles, natural language processing applications, and so forth. In an embodiment, the neural network model includes one or more layers of neurons, where each neuron calculates a weighted sum (e.g., multiply-accumulate/MAC result) of the inputs to the neuron, adds a bias, and then decides the extent to which the neuron should be fired/activated in accordance with an activation function.

As will be discussed in greater detail, embodiments combine the sharing of MAC hardware between different types of convolution operations (e.g., PWC, C2D and DWC) with feeding the MAC hardware with minimal-to-no structural changes (e.g., utilizing the same adder trees and MACs). The convolution chaining/pipelining of convolution operations—without accessing external memory—is a more efficient way to perform from a bandwidth perspective. Although such an approach typically suffers from low MACs utilization, the technology described herein enables multiple convolutions to be pipelined without decreasing utilization. Thus, all MAC hardware may be allocated to carry out the selected convolution operations in a relatively efficient way.

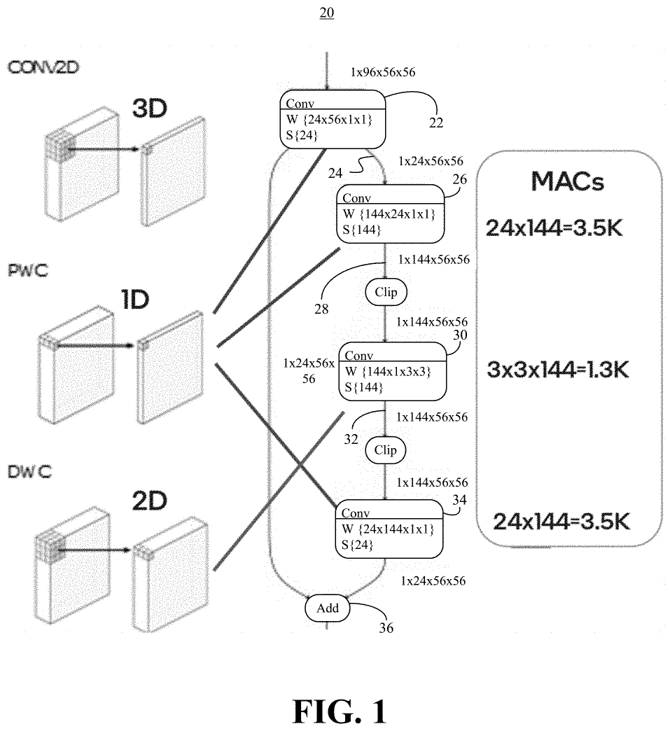

Turning now to FIG. 1, a CNN 20 (e.g., or portion thereof) is shown in which a first one-dimensional (1D) convolutional layer 22 (e.g., point wise convolution/PWC layer) generates activations 24 for a second 1D convolutional layer 26 (e.g., PWC layer), which in turn generates activations 28 for a first two-dimensional (2D) convolutional layer 30 (e.g., depthwise convolution/DWC layer). Additionally, the first 2D convolutional layer 30 generates activations 32 for a third 1D convolutional layer 34 (e.g., DWC layer), wherein the output of the third 1D convolutional layer 34 is combined in an adder 36.

In one example, the 1D convolutional layers 22, 26, 34 use a relatively high number of the activations 24, 28 (e.g., across all input channels) multiplied by a relatively high number of weights into a single accumulator to calculate a single output channel. This calculation of a single output channel is repeated 1) many times until all input channels are taken into account, and 2) in parallel for different pixels and output channels. As will be discussed in greater detail, adder trees facilitate this calculation by taking several input channels (e.g., eight input channels) and producing the calculation for a single accumulator. The adder trees, however, may consume a significant amount of power during operation. By contrast, the 2D convolutional layer 30 has less parallelism, with each input channel affecting only a single output channel. As a result, using the same approach to feed the activations 24, 28, 32, and weights to the MAC hardware that performs both the DWC operations and the PWC operations may result in lower utilization of the MAC hardware during the DWC operations.

For example, the number of MACs used during the PWC operations would be on the order of 3.5K, whereas the number of MACs used during the DWC operations would be on the order of 1.3K (e.g., a DWC:PWC ratio of approximately 1:3). Thus, designing the MAC hardware to support a 1:3 ratio of DWC operations may result in relatively low utilization of the MAC hardware during DWC operations occurring with respect to other portions of the CNN 20 having a different DWC:PWC ratio of, for example, 1:10. As will be discussed in greater detail, the technology described herein swaps weight inputs with activation inputs to shared MAC hardware based on convolution type. Thus, the same MAC hardware can carry out very different calculations. As a result, the adder tree structure of the shared MAC hardware may remain fixed between the PWC operations and the DWC operations. In one example, the fixed adder tree structure reduces power and enhances performance.

As will also be discussed in greater detail, re-purposing the MAC hardware is a way to achieve high utilization with different convolution types and MAC sharing is a way to chain different convolutions and save bandwidth/power. Indeed, chaining convolutions enables the output to be written only at a point when the write out is advantageous. For example, the illustrated second 1D convolutional layer 26 has an output of WxHx144, the illustrated first 2D convolutional layer 30 has an output of WxHx144, and the illustrated third 1D convolutional layer 34 has an output of WxHx24. By chaining the convolutions, the technology described herein can write only the output of the third 1D convolutional layer 34, which is significantly smaller. Accordingly, a significant amount of bandwidth and power is saved.

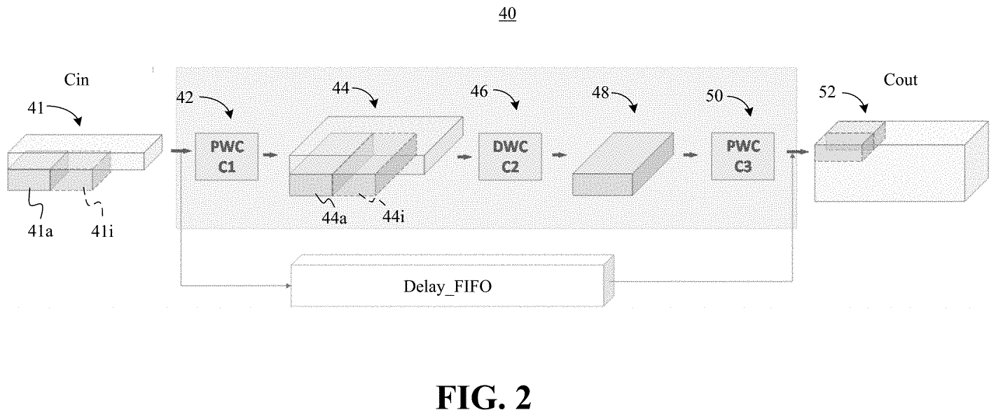

FIG. 2 shows a MAC sharing solution 40 in which a first PWC operation 42 receives input convolutions 41 (41a, 41i, . . . , e.g., LxPxC1in) and outputs activations 44 (44a, 44i, . . . , e.g., LxPxC1out) to a DWC operation 46. The DWC operation 46 outputs activations 48 (e.g., LxPxC2out) to a second PWC operation 50, which in turn outputs activations 52 (e.g., LxPxC3out).

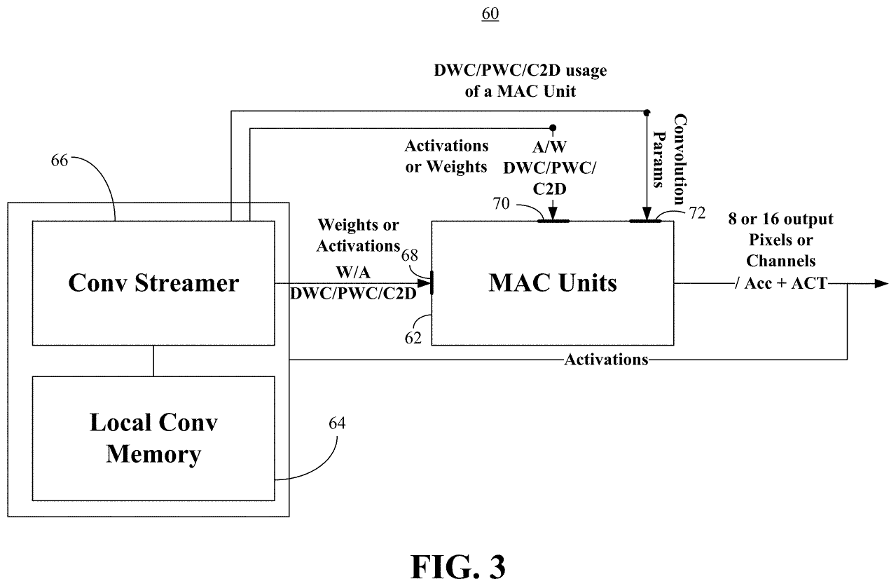

FIG. 3 shows a machine learning architecture 60 that re-purposes MAC hardware 62 in its entirety between multiple convolutions of PWC or DWC operations and time-shares local memory 64 between the layers. Time-sharing involves sharing the same hardware while performing dynamic task switches. To achieve higher utilization during the task switches, the MAC hardware 62 is also re-purposed from PWC operations to DWC operations. The PWC operations may yield full utilization of the MAC hardware 62 while the utilization of the MAC hardware 62 during the DWC operations may depend on the implementation (e.g., reaching 75% for a 3×3 filter size or 87.5% for a 7×7 filter size), while still maintaining the basic manner of operation in the MAC hardware 62.

Additionally, an intelligent convolution streamer 66 may stream weights, activations and parameters (e.g., shift-scale and activation) to the MAC hardware 62, carrying out PWC (e.g., 1D convolutions) as well as DWC (e.g., 2D convolutions) in a shared way of operation. Thus, the MAC hardware 62 may be designed for PWC operations and re-purposed for DWC operations.

More particularly, the MAC hardware 62 may be optimized for PWC and re-purposed for DWC by swapping the weights (W) and activation (A) inputs. For example, weights may be sent to a first input 68 of the shared MAC hardware 62 and activations may be sent to a second input 70 of the shared MAC hardware 62 during DWC operation. During PWC operation, however, weights may be sent to the second input 70 of the shared MAC hardware with activations being sent to the first input 68 of the shared MAC hardware 62. In this regard, PWC operations typically involve a relatively high number of weights while DWC operations may involve a relatively high number of input channels and a relatively low number of weights. Thus, swapping the weights with the activations enables the multipliers within the shared MAC hardware 62 to be used more fully.

The re-purposing of the MAC hardware 62 PWC to DWC can be done in several ways. For example, multiplexing the inputs 68, 70 to the shared MAC hardware 62 combined with appropriate preparation of the data, weights and parameters is one approach. Additionally, convolution parameters provided to a third input 72 of the shared MAC hardware 62 may be adjusted based on the weights. Thus, fixed MAC hardware 62 is used and the convolution streamer 66 prepares the activations, weights and parameters for the convolutions in a chained manner (e.g., one convolution output goes into the next convolution without accessing far memory).

For example, if a PWC involves 64 MACs working on 8-ICs (input channels) and 64 weights, with an output of 8-OCs (output channels), DWC might work on 8 or 16 pixels from a single input channel (e.g., for each MAC Unit as described—multiple MAC Units are possible to work on multiple lines and multiple channels).

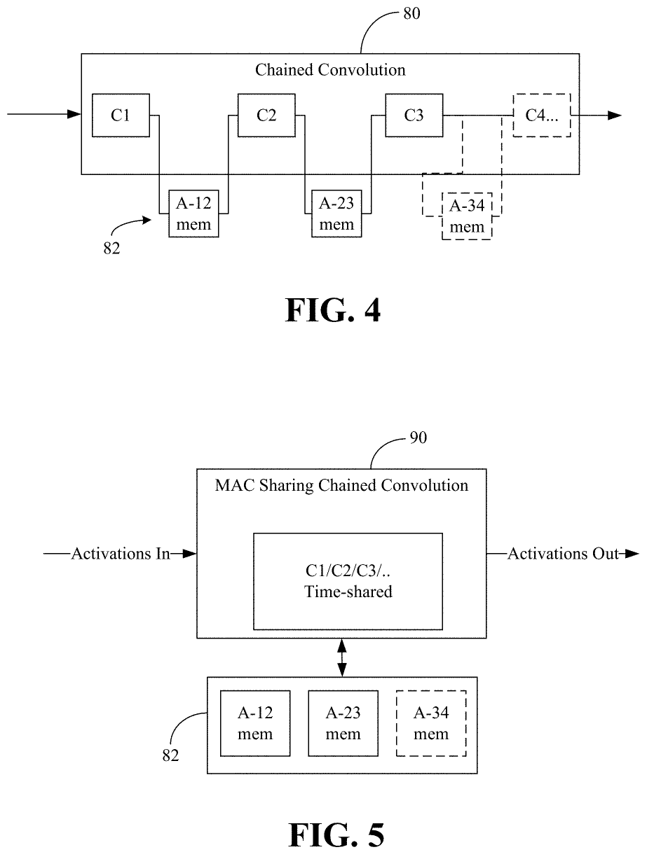

FIG. 4 shows a typical chained (e.g., concatenated) convolution 80 through a local memory 82 without the need to access far memory (e.g., dynamic random access memory/DRAM). A typical problem of such an approach in terms of utilization is that if all convolutions are not balanced, a single convolution can slow down the remaining convolutions through the activations in the activations memory.

FIG. 5 demonstrates that a MAC sharing chained convolution 90 uses both the chained convolution 80 (FIG. 4) and improved utilization without the need to balance the convolutions. In the illustrated example, the progress of the convolutions is merely data driven—when enough data is available in the local memory 82 to conduct calculations on a pending convolution—the pending convolution is invoked and the entire MAC hardware carries out the calculation for the convolution as soon as possible (e.g., freeing input memory for the previous convolution to continue).

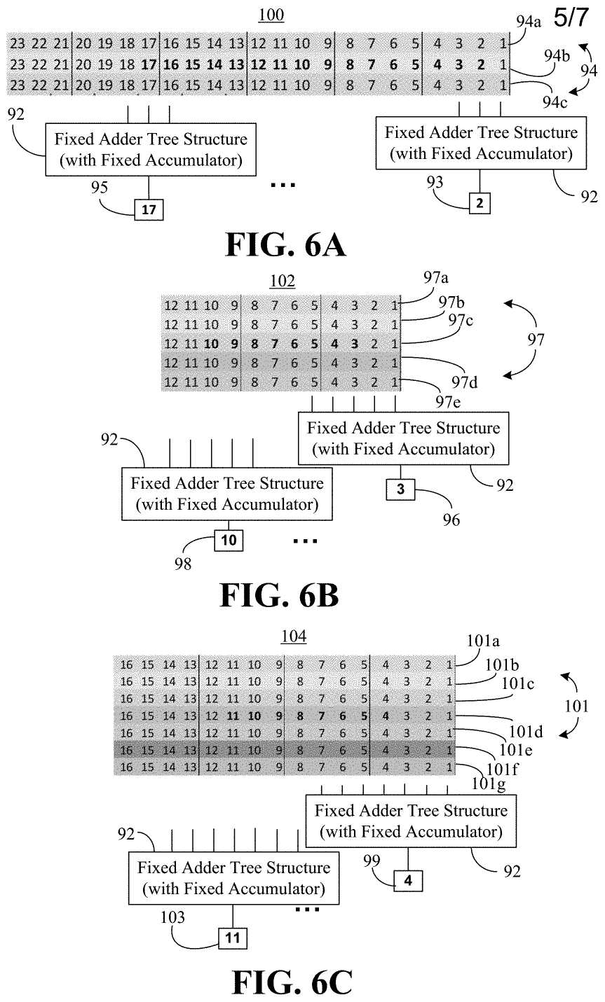

In addition to MAC Sharing with local buffers, a very similar structure may be used for 1D and 2D convolutions (e.g., PWD, C2D and DWC) while keeping the MAC hardware infrastructure with minimal impact on utilization. In an embodiment, 8-multiplier adder trees (e.g., the basic MAC unit structure) may be fed in accordance with the filter size (e.g., 3×3, 5×5, 7×7), keeping eight or sixteen accumulated outputs and still reaching very high utilization in the supported strides. In one example, FilterSize number of steps is used to complete the calculation without stalling the MAC hardware more than necessary and returning the MAC hardware to the other shared/chained convolutions (e.g., PWC, C2D, DWC). FIGS. 6A-6C show adder tree multipliers for a 3×3 filter size, a 5×5 filter size, and a 7×7 filter size, respectively, when conducting DWC operations.

As best shown in FIG. 6A, a 3×3 example 100 demonstrates that a fixed adder tree structure 92 (e.g., with a fixed number of multipliers and a fixed accumulator) may generate an accumulation result 93 for a designated pixel (e.g., pixel “2”) by performing a multi-cycle multiplication operation 94 (94a-94c). In the illustrated example, a first cycle operation 94a multiplies activations and weights for a first row of pixels (e.g., pixels “1”-“3”), a second cycle operation 94b multiplies activations and weights for a second row of pixels, and a third cycle operation 94c multiplies activations and weights for a third row of pixels, with the output of the multi-cycle multiplication operation 94 being summed into the accumulation result 93. In an embodiment, the fixed adder tree structure 92 is shifted through the pixels (e.g., in accordance with a predetermined stride) and similarly generates an accumulation result 95 for other pixels such as, for example, pixel “17”. Thus, the number of cycles (e.g., three) in the multi-cycle multiplication operation 94 is a function of the filter size (e.g., 3×3). In one example, the multipliers of the fixed adder tree structure 92 are selectively enabled/used during the 2D convolution operation(s) based on filter size.

As best shown in FIG. 6B, a 5×5 example 102 demonstrates that the fixed adder tree structure 92 may generate an accumulation result 96 for a designated pixel (e.g., pixel “3”) by performing a multi-cycle multiplication operation 97 (97a-97e). In the illustrated example, a first cycle operation 97a multiplies activations and weights for a first row of pixels (e.g., pixels “1”-“5”), a second cycle operation 97b multiplies activations and weights for a second row of pixels, and so forth, with the output of the multi-cycle multiplication operation 97 being summed into the accumulation result 96. In an embodiment, the fixed adder tree structure 92 is shifted through the pixels and similarly generates an accumulation result 98 for other pixels such as, for example, pixel “10”. Again, the number of cycles (e.g., five) in the multi-cycle multiplication operation 97 is a function of the filter size (e.g., 5×5) and the multipliers of the fixed adder tree structure 92 are selectively enabled/used during the 2D convolution operation(s) based on filter size.

As best shown in FIG. 6C, a 7×7 example 104 demonstrates that the fixed adder tree structure 92 generates an accumulation result 99 for a designated pixel (e.g., pixel “4”) by performing a multi-cycle multiplication operation 101 (101a-101g). In the illustrated example, a first cycle operation 101a multiplies activations and weights for a first row of pixels (e.g., pixels 1”-“7”), a second cycle operation 101b multiplies activations and weights for a second row of pixels, and so forth, with the output of the multi-cycle multiplication operation 101 being summed into the accumulation result 99. In an embodiment, the fixed adder tree structure 92 is shifted through the pixels and similarly generates an accumulation result 103 for other pixels such as, for example, pixel “11”. Again, the number of cycles (e.g., seven) in the multi-cycle multiplication operation 101 is a function of the filter size (e.g., 7×7) and the multipliers of the fixed adder tree structure 92 are selectively enabled/used during the 2D convolution operation(s) based on filter size.

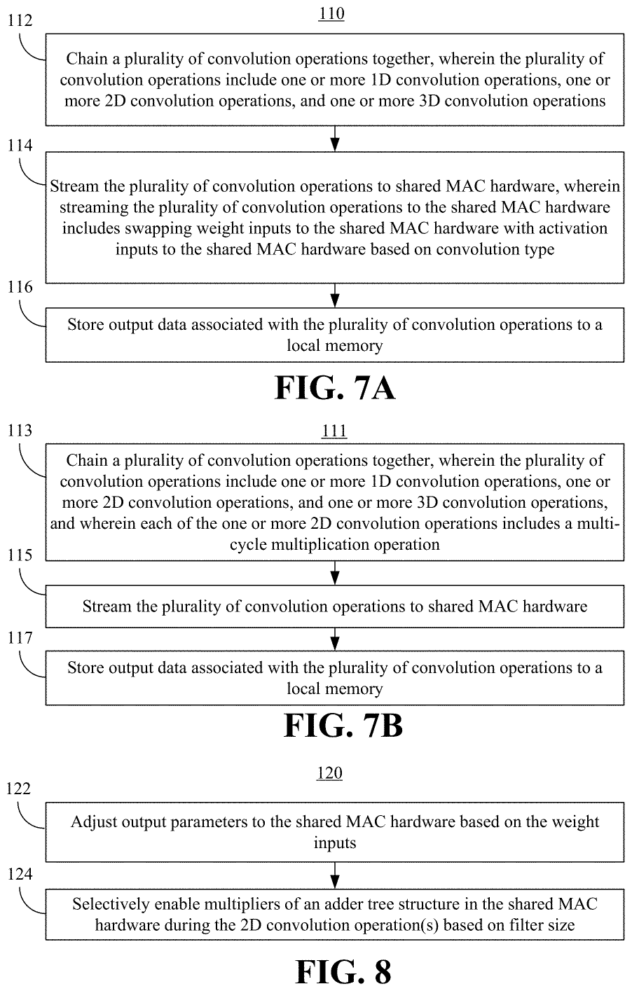

FIG. 7A shows a method 110 of operating a performance-enhanced computing system. The method 110 may generally be implemented in a convolution streamer such as, for example, the convolution streamer 66 (FIG. 3), already discussed. More particularly, the method 110 may be implemented in one or more modules a set of logic instructions stored in a machine- or computer-readable storage medium such as random access memory (RAM), read only memory (ROM), programmable ROM (PROM), firmware, flash memory, etc., in hardware, or any combination thereof. For example, hardware implementations may include configurable logic, fixed-functionality logic, or any combination thereof. Examples of configurable logic (e.g., configurable hardware) include suitably configured programmable logic arrays (PLAs), field programmable gate arrays (FPGAs), complex programmable logic devices (CPLDs), and general purpose microprocessors. Examples of fixed-functionality logic (e.g., fixed-functionality hardware) include suitably configured application specific integrated circuits (ASICs), combinational logic circuits, and sequential logic circuits. The configurable or fixed-functionality logic can be implemented with complementary metal oxide semiconductor (CMOS) logic circuits, transistor-transistor logic (TTL) logic circuits, or other circuits.

Illustrated processing block 112 provides for chaining (e.g., concatenating) a plurality of convolution operations together, wherein the plurality of convolution operations include one or more 1D convolution operations, one or more 2D convolution operations, and one or more three-dimensional (3D) convolution operations. In an embodiment, the 1D convolution operation(s) include pixel wise convolution operations and the 2D convolution operation(s) include depth wise convolution operations. The 3D convolution operation(s) can also include C2D operations. Thus, the plurality of convolution operations involve very different types of calculations.

Block 114 streams the plurality of convolution operations to shared MAC hardware, wherein streaming the plurality of convolution operations to the shared MAC hardware includes swapping (e.g., task switching in an alternative order) weight inputs to the shared MAC hardware with activation inputs to the shared MAC hardware based on convolution type. In an embodiment, one or more of an adder tree structure or an accumulator of the shared MAC hardware is fixed between the 1D convolution operation(s) and the 2D convolution operation(s). Illustrated block 116 stores output data associated with the plurality of convolution operations to a local memory (e.g., bypassing reads/writes with respect to system memory/DRAM). In one example, the utilization of the MAC hardware during the 2D convolution operation(s) is a function of filter size. Additionally, the utilization of the MAC hardware during the 1D/3D convolution operation(s) may be a full utilization (e.g., 100%).

The method 110 therefore enhances performance at least to the extent that swapping weight inputs with activation inputs enables the shared MAC hardware to reach higher utilization levels even with the substantially different calculations involved. As a result, the convolutions can be completed much faster than in conventional solutions. Additionally, using a fixed adder tree structure between the different types of convolution operations significantly reduces power consumption. Indeed, power consumption is further reduced by chaining the convolution operations together and restricting the storage of output data (e.g., intermediate results) to the local memory. This reduced power consumption (and lower cost) may be particularly advantageous in edge inference use cases. Chaining the convolutions also substantially reduces the bandwidth associated with accessing external/far memory.

FIG. 7B shows another method 111 of operating a performance-enhanced computing system. The method 111 may generally be implemented in a convolution streamer such as, for example, the convolution streamer 66 (FIG. 3), already discussed. More particularly, the method 111 may be implemented in one or more modules as a set of logic instructions stored in a machine- or computer-readable storage medium RAM, ROM, PROM, firmware, flash memory, etc., in hardware, or any combination thereof.

Illustrated processing block 113 provides for chaining (e.g., concatenating) a plurality of convolution operations together, wherein the plurality of convolution operations include one or more 1D convolution operations, one or more 2D convolution operations, and one or more 3D convolution operations. In the illustrated example, each of the 2D operations includes a multi-cycle multiplication operation. For example, the number of cycles in the multi-cycle multiplication operation is a function of filter size. In an embodiment, the 1D convolution operation(s) include pixel wise convolution operations and the 2D convolution operation(s) include depth wise convolution operations. The 3D convolution operation(s) can also include C2D operations. Thus, the plurality of convolution operations involve very different types of calculations.

Block 115 streams the plurality of convolution operations to shared MAC hardware. In an embodiment, one or more of an adder tree structure or an accumulator of the shared MAC hardware is fixed between the 1D convolution operation(s) and the 2D convolution operation(s). Illustrated block 117 stores output data associated with the plurality of convolution operations to a local memory (e.g., bypassing reads/writes with respect to system memory/DRAM). In one example, the utilization of the MAC hardware during the 2D convolution operation(s) is a function of filter size. Additionally, the utilization of the MAC hardware during the 1D/3D convolution operation(s) may be a full utilization (e.g., 100%).

The method 111 therefore enhances performance at least to the extent that performing the multi-cycle multiplication operations enables the shared MAC hardware to reach higher utilization levels even with the substantially different calculations involved. As a result, the convolutions can be completed much faster than in conventional solutions. Additionally, using a fixed adder tree structure between the different types of convolution operations significantly reduces power consumption. Indeed, power consumption is further reduced by chaining the convolution operations together and restricting the storage of output data (e.g., intermediate results) to the local memory. This reduced power consumption (and lower cost) may be particularly advantageous in edge inference use cases. Chaining the convolutions also substantially reduces the bandwidth associated with accessing external/far memory.

FIG. 8 shows a method 120 of streaming a plurality of convolution operations to shared MAC hardware. The method 120 may generally be incorporated into block 114 (FIG. 7A) and/or block 115 (FIG. 7B), already discussed. More particularly, the method 120 may be implemented in one or more modules as a set of logic instructions stored in a machine- or computer-readable storage medium RAM, ROM, PROM, firmware, flash memory, etc., in hardware, or any combination thereof.

Illustrated processing block 122 provides for adjusting convolution parameters to the shared MAC hardware based on the weight inputs. Thus, the convolution parameters follow the weight inputs regardless of the type of convolution in the illustrated example. Block 124 selectively enables multipliers of an adder tree structure in the shared MAC hardware during the 2D convolution operation(s) based on filter size (e.g., while the structure itself remains the same).

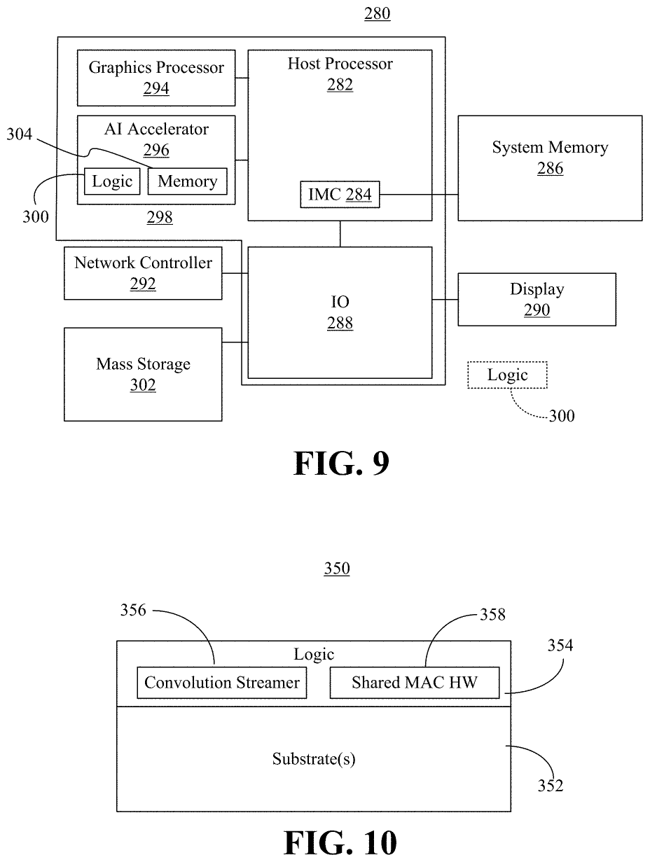

Turning now to FIG. 9, a performance-enhanced computing system 280 is shown. The system 280 may generally be part of an electronic device/platform having computing functionality (e.g., personal digital assistant/PDA, notebook computer, tablet computer, convertible tablet, server), communications functionality (e.g., smart phone), imaging functionality (e.g., camera, camcorder), media playing functionality (e.g., smart television/TV), wearable functionality (e.g., watch, eyewear, headwear, footwear, jewelry), vehicular functionality (e.g., car, truck, motorcycle), robotic functionality (e.g., autonomous robot), Internet of Things (IoT) functionality, etc., or any combination thereof.

In the illustrated example, the system 280 includes a host processor 282 (e.g., central processing unit/CPU) having an integrated memory controller (IMC) 284 that is coupled to a system memory 286 (e.g., dual inline memory module/DIMM, far memory). In an embodiment, an IO (input/output) module 288 is coupled to the host processor 282. The illustrated IO module 288 communicates with, for example, a display 290 (e.g., touch screen, liquid crystal display/LCD, light emitting diode/LED display), mass storage 302 (e.g., hard disk drive/HDD, optical disc, solid state drive/SSD) and a network controller 292 (e.g., wired and/or wireless). The host processor 282 may be combined with the IO module 288, a graphics processor 294, and an AI accelerator 296 into a system on chip (SoC) 298.

In an embodiment, the AI accelerator 296 includes logic 300 and local memory 304, wherein the logic 300 performs one or more aspects of the method 110 (FIG. 7A), the method 111 (FIG. 7B) and/or the method 120 (FIG. 8), already discussed. The logic 300 may therefore chain a plurality of convolution operations together, wherein the plurality of convolution operations include one or more 1D convolution operations and one or more 2D convolution operations, and stream the plurality of convolution operations to shared MAC hardware (not shown) of the logic 300. To stream the plurality of convolution operations to the shared MAC hardware, the logic 300 swaps (e.g., task switches) weight inputs to the shared MAC hardware with activation inputs to the shared MAC hardware based on convolution type. The logic 300 may also store output data/intermediate results associated with the plurality of convolution operations to the local memory 304.

Additionally, the logic 300 may chain a plurality of convolution operations together, wherein the plurality of convolution operations include one or more 1D convolution operations and one or more 2D convolution operations, and wherein each of the 2D convolution operation(s) includes a multi-cycle multiplication operation. Again, the logic 300 streams the plurality of convolution operations to shared MAC hardware (not shown) of the logic 300. The logic 300 may also store output data/intermediate results associated with the plurality of convolution operations to the local memory 304.

The computing system 280 is therefore considered performance-enhanced at least to the extent that swapping weight inputs with activation inputs and/or conducting multi-cycle multiplication operations enables the shared MAC hardware to reach higher utilization levels even with the substantially different calculations involved. Additionally, using a fixed adder tree structure between the different types of convolution operations significantly reduces power consumption. Indeed, power consumption is further reduced by chaining the convolution operations together and restricting the storage of output data to the local memory.

FIG. 10 shows a semiconductor apparatus 350 (e.g., chip, die, package). The illustrated apparatus 350 includes one or more substrates 352 (e.g., silicon, sapphire, gallium arsenide) and logic 354 (e.g., transistor array and other integrated circuit/IC components) coupled to the substrate(s) 352. The logic 354, which includes a convolution streamer 356 and shared MAC hardware (HW) 358 may be readily substituted for the logic 300 (FIG. 9), already discussed. In an embodiment, the logic 354 implements one or more aspects of the method 110 (FIG. 7A), the method 111 (FIG. 7B) and/or the method 120 (FIG. 8), already discussed.

The logic 354 may be implemented at least partly in configurable or fixed-functionality hardware. In one example, the logic 354 includes transistor channel regions that are positioned (e.g., embedded) within the substrate(s) 352. Thus, the interface between the logic 354 and the substrate(s) 352 may not be an abrupt junction. The logic 354 may also be considered to include an epitaxial layer that is grown on an initial wafer of the substrate(s) 352.

### Additional Notes and Examples

Example 1 includes a performance-enhanced computing system comprising a network controller and a processor coupled to the network controller, wherein the processor includes a local memory and logic coupled to one or more substrates, the logic to chain a plurality of convolution operations together, wherein the plurality of convolution operations include one or more one-dimensional (1D) convolution operations and one or more two-dimensional (2D) convolution operations, stream the plurality of convolution operations to shared multiply-accumulate (MAC) hardware of the logic, wherein to stream the plurality of convolution operations to the shared MAC hardware, the logic is to swap weight inputs to the shared MAC hardware with activation inputs to the shared MAC hardware based on convolution type, and store output data associated with the plurality of convolution operations to the local memory.

Example 2 includes the computing system of Example 1, wherein one or more of an adder tree structure or an accumulator of the MAC hardware is fixed between the one or more 1D convolution operations and the one or more 2D convolution operations.

Example 3 includes the computing system of Example 2, wherein the logic is further to selectively enable multipliers of the adder tree structure during the one or more 2D convolution operations based on filter size.

Example 4 includes the computing system of Example 1, wherein a utilization of the MAC hardware during the one or more 2D convolution operations is to be a function of a filter size.

Example 5 includes the computing system of Example 1, wherein a utilization of the MAC hardware during the one or more 1D operations is to be a full utilization.

Example 6 includes the computing system of Example 1, wherein the plurality of convolution operations further include one or more three-dimensional (3D) convolution operations.

Example 7 includes the computing system of Example 1, wherein the one or more 1D convolution operations include pixel wise convolution operations and the one or more 2D convolution operations include depth wise convolution operations.

Example 8 includes the computing system of any one of Examples 1 to 7, wherein to stream the plurality of convolution operations to the shared MAC hardware, the logic is further to adjust convolution parameters to the shared MAC hardware based on the weight inputs.

Example 9 includes a semiconductor apparatus comprising one or more substrates, and logic coupled to the one or more substrates, wherein the logic is implemented at least partly in one or more of configurable or fixed-functionality hardware, the logic to chain a plurality of convolution operations together, wherein the plurality of convolution operations include one or more one-dimensional (1D) convolution operations and one or more two-dimensional (2D) convolution operations, stream the plurality of convolution operations to shared multiply-accumulate (MAC) hardware of the logic, wherein to stream the plurality of convolution operations to the shared MAC hardware, the logic is to swap weight inputs to the shared MAC hardware with activation inputs to the shared MAC hardware based on convolution type, and store output data associated with the plurality of convolution operations to a local memory.

Example 10 includes the semiconductor apparatus of Example 9, wherein one or more of an adder tree structure or an accumulator of the MAC hardware is fixed between the one or more 1D convolution operations and the one or more 2D convolution operations.

Example 11 includes the semiconductor apparatus of Example 10, wherein the logic is further to selectively enable multipliers of the adder tree structure during the one or more 2D convolution operations based on filter size.

Example 12 includes the semiconductor apparatus of Example 9, wherein a utilization of the MAC hardware during the one or more 2D convolution operations is to be a function of a filter size.

Example 13 includes the semiconductor apparatus of Example 9, wherein a utilization of the MAC hardware during the one or more 1D convolution operations is to be a full utilization.

Example 14 includes the semiconductor apparatus of Example 9, wherein the plurality of convolution operations further include one or more three-dimensional (3D) convolution operations.

Example 15 includes the semiconductor apparatus of Example 9, wherein the one or more 1D convolution operations include pixel wise convolution operations and the one or more 2D convolution operations include depth wise convolution operations.

Example 16 includes the semiconductor apparatus of any one of Examples 9 to 15, wherein to stream the plurality of convolution operations to the shared MAC hardware, the logic is further to adjust convolution parameters to the shared MAC hardware based on the weight inputs.

Example 17 includes the semiconductor apparatus of any one of Examples 9 to 16, wherein the logic coupled to the one or more substrates includes transistor channel regions that are positioned within the one or more substrates.

Example 18 includes a performance-enhanced computing system comprising a network controller, and a processor coupled the network controller, wherein the processor includes a local memory and logic coupled to one or more substrates, the logic to chain a plurality of convolution operations together, wherein the plurality of convolution operations include one or more one-dimensional (1D) convolution operations and one or more two-dimensional (2D) convolution operations, and wherein each of the one or more 2D convolution operations includes a multi-cycle multiplication operation, stream the plurality of convolution operations to shared multiply-accumulate (MAC) hardware of the logic, and store output data associated with the plurality of convolution operations to the local memory.

Example 19 includes the computing system of Example 18, wherein a number of cycles in the multi-cycle multiplication operation is to be a function of filter size.

Example 20 includes the computing system of any one of Examples 18 to 19, wherein one or more of an adder tree structure or an accumulator of the MAC hardware is fixed between the one or more 1D convolution operations and the one or more 2D convolution operations, and wherein the logic is further to selectively enable multipliers of the adder tree structure during the one or more 2D convolution operations based on filter size.

Example 21 includes the computing system of any one of Examples 18 to 20, wherein the one or more 1D convolution operations include pixel wise convolution operations and the one or more 2D convolution operations include depth wise convolution operations.

Example 22 includes a semiconductor apparatus comprising one or more substrates, and logic coupled to the one or more substrates, wherein the logic is implemented at least partly in one or more of configurable or fixed-functionality hardware, the logic to chain a plurality of convolution operations together, wherein the plurality of convolution operations include one or more one-dimensional (1D) convolution operations and one or more two-dimensional (2D) convolution operations, and wherein each of the one or more 2D convolution operations includes a multi-cycle multiplication operation, stream the plurality of convolution operations to shared multiply-accumulate (MAC) hardware of the logic, and store output data associated with the plurality of convolution operations to the local memory.

Example 23 includes the semiconductor apparatus of Example 22, wherein a number of cycles in the multi-cycle multiplication operation is to be a function of filter size.

Example 24 includes the semiconductor apparatus of any one of Examples 22 to 23, wherein one or more of an adder tree structure or an accumulator of the MAC hardware is fixed between the one or more 1D convolution operations and the one or more 2D convolution operations, and wherein the logic is further to selectively enable multipliers of the adder tree structure during the one or more 2D convolution operations based on filter size.

Example 25 includes the semiconductor apparatus of any one of Examples 22 to 24, wherein the one or more 1D convolution operations include pixel wise convolution operations and the one or more 2D convolution operations include depth wise convolution operations.

Example 26 includes an apparatus comprising means for chaining a plurality of convolutions together, wherein the plurality of convolution operations include one or more one-dimensional (1D) convolution operations and one or more two-dimensional (2D) convolution operations, means for streaming the plurality of convolution operations to shared multiply-accumulate (MAC) hardware, wherein to stream the plurality of convolution operations to the shared MAC hardware, the means for swapping is to swap weight inputs to the shared MAC hardware with activation inputs to the shared MAC hardware based on convolution type, and means for storing output data associated with the plurality of convolution operations to a local memory.

Example 27 includes an apparatus comprising means for chaining a plurality of convolution operations together, wherein the plurality of convolution operations include one or more one-dimensional (1D) convolution operations and one or more two-dimensional (2D) convolution operations, and wherein each of the one or more 2D convolution operations includes a multi-cycle multiplication operation, means for streaming the plurality of convolution operations to shared multiply-accumulate (MAC) hardware of the logic, and means for storing output data associated with the plurality of convolution operations to the local memory.

Embodiments are applicable for use with all types of semiconductor integrated circuit (“IC”) chips. Examples of these IC chips include but are not limited to processors, controllers, chipset components, programmable logic arrays (PLAs), memory chips, network chips, systems on chip (SoCs), SSD/NAND controller ASICs, and the like. In addition, in some of the drawings, signal conductor lines are represented with lines. Some may be different, to indicate more constituent signal paths, have a number label, to indicate a number of constituent signal paths, and/or have arrows at one or more ends, to indicate primary information flow direction. This, however, should not be construed in a limiting manner. Rather, such added detail may be used in connection with one or more exemplary embodiments to facilitate easier understanding of a circuit. Any represented signal lines, whether or not having additional information, may actually comprise one or more signals that may travel in multiple directions and may be implemented with any suitable type of signal scheme, e.g., digital or analog lines implemented with differential pairs, optical fiber lines, and/or single-ended lines.

Example sizes/models/values/ranges may have been given, although embodiments are not limited to the same. As manufacturing techniques (e.g., photolithography) mature over time, it is expected that devices of smaller size could be manufactured. In addition, well known power/ground connections to IC chips and other components may or may not be shown within the figures, for simplicity of illustration and discussion, and so as not to obscure certain aspects of the embodiments. Further, arrangements may be shown in block diagram form in order to avoid obscuring embodiments, and also in view of the fact that specifics with respect to implementation of such block diagram arrangements are highly dependent upon the computing system within which the embodiment is to be implemented, i.e., such specifics should be well within purview of one skilled in the art. Where specific details (e.g., circuits) are set forth in order to describe example embodiments, it should be apparent to one skilled in the art that embodiments can be practiced without, or with variation of, these specific details. The description is thus to be regarded as illustrative instead of limiting.

The term “coupled” may be used herein to refer to any type of relationship, direct or indirect, between the components in question, and may apply to electrical, mechanical, fluid, optical, electromagnetic, electromechanical or other connections. In addition, the terms “first”, “second”, etc. may be used herein only to facilitate discussion, and carry no particular temporal or chronological significance unless otherwise indicated.

As used in this application and in the claims, a list of items joined by the term “one or more of” may mean any combination of the listed terms. For example, the phrases “one or more of A, B or C” may mean A; B; C; A and B; A and C; B and C; or A, B and C.

Those skilled in the art will appreciate from the foregoing description that the broad techniques of the embodiments can be implemented in a variety of forms. Therefore, while the embodiments have been described in connection with particular examples thereof, the true scope of the embodiments should not be so limited since other modifications will become apparent to the skilled practitioner upon a study of the drawings, specification, and following claims.

We claim:

1. A computing system comprising:
a network controller; and
a processor coupled the network controller, wherein the processor includes a local memory and logic coupled to one or more substrates, the logic to:
chain a plurality of convolution operations together, wherein the plurality of convolution operations include one or more one-dimensional (1D) convolution operations and one or more two-dimensional (2D) convolution operations,
stream the plurality of convolution operations to shared multiply-accumulate (MAC) hardware of the logic, wherein to stream the plurality of convolution operations to the shared MAC hardware, the logic is to swap weight inputs to the shared MAC hardware with activation inputs to the shared MAC hardware based on convolution type, and
store output data associated with the plurality of convolution operations to the local memory.

2. The computing system of claim 1, wherein one or more of an adder tree structure or an accumulator of the MAC hardware is fixed between the one or more 1D convolution operations and the one or more 2D convolution operations.

3. The computing system of claim 2, wherein the logic is further to selectively enable multipliers of the adder tree structure during the one or more 2D convolution operations based on filter size.

4. The computing system of claim 1, wherein a utilization of the MAC hardware during the one or more 2D convolution operations is to be a function of a filter size.

5. The computing system of claim 1, wherein a utilization of the MAC hardware during the one or more 1D operations is to be a full utilization.

6. The computing system of claim 1, wherein the plurality of convolution operations further include one or more three-dimensional (3D) convolution operations.

7. The computing system of claim 1, wherein the one or more 1D convolution operations include pixel wise convolution operations and the one or more 2D convolution operations include depth wise convolution operations.

8. The computing system of claim 1, wherein to stream the plurality of convolution operations to the shared MAC hardware, the logic is further to adjust convolution parameters to the shared MAC hardware based on the weight inputs.

9. A semiconductor apparatus comprising:
one or more substrates; and
logic coupled to the one or more substrates, wherein the logic is implemented at least partly in one or more of configurable or fixed-functionality hardware, the logic to:
chain a plurality of convolution operations together, wherein the plurality of convolution operations include one or more one-dimensional (1D) convolution operations and one or more two-dimensional (2D) convolution operations;
stream the plurality of convolution operations to shared multiply-accumulate (MAC) hardware of the logic, wherein to stream the plurality of convolution operations to the shared MAC hardware, the logic is to swap weight inputs to the shared MAC hardware with activation inputs to the shared MAC hardware based on convolution type; and
store output data associated with the plurality of convolution operations to a local memory.

10. The semiconductor apparatus of claim 9, wherein one or more of an adder tree structure or an accumulator of the MAC hardware is fixed between the one or more 1D convolution operations and the one or more 2D convolution operations.

11. The semiconductor apparatus of claim 10, wherein the logic is further to selectively enable multipliers of the adder tree structure during the one or more 2D convolution operations based on filter size.

12. The semiconductor apparatus of claim 9, wherein a utilization of the MAC hardware during the one or more 2D convolution operations is to be a function of a filter size.

13. The semiconductor apparatus of claim 9, wherein a utilization of the MAC hardware during the one or more 1D convolution operations is to be a full utilization.

14. The semiconductor apparatus of claim 9, wherein the plurality of convolution operations further include one or more three-dimensional (3D) convolution operations.

15. The semiconductor apparatus of claim 9, wherein the one or more 1D convolution operations include pixel wise convolution operations and the one or more 2D convolution operations include depth wise convolution operations.

16. The semiconductor apparatus of claim 9, wherein to stream the plurality of convolution operations to the shared MAC hardware, the logic is further to adjust convolution parameters to the shared MAC hardware based on the weight inputs.

17. The semiconductor apparatus of claim 9, wherein the logic coupled to the one or more substrates includes transistor channel regions that are positioned within the one or more substrates.

18. A computing system comprising:
a network controller; and
a processor coupled the network controller, wherein the processor includes a local memory and logic coupled to one or more substrates, the logic to:
chain a plurality of convolution operations together, wherein the plurality of convolution operations include one or more one-dimensional (1D) convolution operations and one or more two-dimensional (2D) convolution operations, and wherein each of the one or more 2D convolution operations includes a multi-cycle multiplication operation,
stream the plurality of convolution operations to shared multiply-accumulate (MAC) hardware of the logic, and
store output data associated with the plurality of convolution operations to the local memory.

19. The computing system of claim 18, wherein a number of cycles in the multi-cycle multiplication operation is to be a function of filter size.

20. The computing system of claim 18, wherein one or more of an adder tree structure or an accumulator of the MAC hardware is fixed between the one or more 1D convolution operations and the one or more 2D convolution operations, and wherein the logic is further to selectively enable multipliers of the adder tree structure during the one or more 2D convolution operations based on filter size.

21. The computing system of claim 18, wherein the one or more 1D convolution operations include pixel wise convolution operations and the one or more 2D convolution operations include depth wise convolution operations.

22. A semiconductor apparatus comprising:
one or more substrates; and
logic coupled to the one or more substrates, wherein the logic is implemented at least partly in one or more of configurable or fixed-functionality hardware, the logic to:
chain a plurality of convolution operations together, wherein the plurality of convolution operations include one or more one-dimensional (1D) convolution operations and one or more two-dimensional (2D) convolution operations, and wherein each of the one or more 2D convolution operations includes a multi-cycle multiplication operation,
stream the plurality of convolution operations to shared multiply-accumulate (MAC) hardware of the logic, and
store output data associated with the plurality of convolution operations to the local memory.

23. The semiconductor apparatus of claim 22, wherein a number of cycles in the multi-cycle multiplication operation is to be a function of filter size.

24. The semiconductor apparatus of claim 22, wherein one or more of an adder tree structure or an accumulator of the MAC hardware is fixed between the one or more 1D convolution operations and the one or more 2D convolution operations, and wherein the logic is further to selectively enable multipliers of the adder tree structure during the one or more 2D convolution operations based on filter size.

25. The semiconductor apparatus of claim 22, wherein the one or more 1D convolution operations include pixel wise convolution operations and the one or more 2D convolution operations include depth wise convolution operations.
